(19) United States
(12) Patent Application Publication
(10) Pub. No.: US 2006/0208595 A1
(43) Pub. Date: Sep. 21, 2006

(54) THREE-PHASE SYNCHRONOUS AC GENERATOR WITH ELECTRICALLY PHASE SHIFTED STATOR WINDINGS FOR REDUCED MECHANICAL AND MAGNETIC NOISE

(76) Inventor: Michael D. Bradfield, Anderson, IN (US)

Correspondence Address: CANTOR COLBURN LLP-IBM POUGHKEEPSIE, 55 GRIFFIN ROAD SOUTH, BLOOMFIELD, CT, 06002, US

(21) Appl. No.: 11/080,746

(22) Filed: Mar. 15, 2005

(51) Int. Cl. H02K 3/00; H02K 1/00

(52) U.S. Cl. 310/179

(57) ABSTRACT

A stator assembly for a dynamoelectric machine includes a core having a plurality of stator teeth and n sets of independent, three-phase windings disposed around the core. Each of the three phase windings are shifted from one adjacent slot winding by an electrical angle of π/(3n)+θ, and are shifted from the opposite adjacent slot winding by an electrical angle of π/(3n)−θ.

### BACKGROUND

The present invention relates generally to rotating electric machinery and, more particularly, to a three-phase, synchronous alternating current (AC) generator having electrically phase shifted stator windings for reduced mechanical and magnetic noise.

Generators are found in virtually every motor vehicle manufactured today. These generators, also referred to as alternators, produce electricity necessary to power a vehicle's electrical accessories, as well as to charge a vehicle's battery. Generators must also provide the capability to produce electricity in sufficient quantities so to power a vehicle's electrical system in a manner that is compatible with the vehicle's electrical components. Furthermore, electrical loads for vehicles continue to escalate while, at the same time, the overall package size available for the electrical generator continues to shrink. Consequently, there is a continuing need for a higher power density system and method of generating on-board electricity.

Moreover, for vehicle applications, it is also desirable to be able to reduce the underhood noise associated with three-phase alternating current (AC) produced by an alternator. In particular, the generated three-phase alternating current is rectified into a direct current (DC), which can be stored in a battery of a vehicle or be used directly by the electrical circuitry of the vehicle, which is nominally supplied by a direct current (DC) voltage. More specifically, this underhood noise stems from the magnetic forces of the magnetic flux.

A generator typically includes a stator assembly having a stator core and a stator winding, and a rotor. Conventionally, the stator core contains the main current carrying windings (i.e., the “stator windings”) in which electromotive force produced by magnetic flux is induced. The core contains a plurality of radially-inwardly projecting teeth separated by intervening slots. Each slot has an open bottom formed by tooth tips of adjacent stator teeth. The slot opening is conventionally relatively narrow, compared with the width of the slot itself. The narrow slot opening in conventional arrangements, however, is not an accident, but rather a deliberate choice, ostensibly to provide both a magnetic flux path and to provide for wire retention. Conventionally, the stator windings may be wound and inserted into the slots in bundles. There are, however, shortcomings with conventional arrangements.

Another source of underhood noise discussed above can result from air generated by internal generator fans, which exits across the end turn windings of the stator. When the stator windings are uniformly spaced (e.g., by a consistent 30 degree electrical angle), the openings, or holes, that naturally form in the end turns as a function of the wire routing, are correspondingly uniformly spaced (30 electrical degrees) apart thus setting up a mechanical noise harmonic with the fan blades. Accordingly, while such spacing, by itself, may improve magnetic noise, there may be a trade off with respect to mechanical noise.

In view of the above, it would be desirable to be able to reduce magnetically and mechanically induced noise in the alternator and, additionally, to produce such an alternator in a manner that eliminates the need for axial insertion of the windings and multiple welding steps.

### SUMMARY

The foregoing discussed drawbacks and deficiencies of the prior art are overcome or alleviated by a stator assembly for a dynamoelectric machine. In an exemplary embodiment, the stator assembly includes a core having a plurality of stator teeth and n sets of independent, three-phase windings disposed around the core. Each of the three phase windings are shifted from one adjacent slot winding by an electrical angle of π/(3n)+θ, and are shifted from the opposite adjacent slot winding by an electrical angle of π/(3n)−θ.

In another embodiment, a dynamoelectric machine includes a rotor having two or more flux carrying segments, with each segment having P/2 claw poles, wherein P is an even number. A stator assembly has the rotor rotatingly disposed therein, the stator assembly further including a core having a plurality of stator teeth and n sets of independent, three-phase windings disposed around the core. Each of the three phase windings are shifted from one adjacent slot winding by an electrical angle of π/(3n)+θ, and are shifted from the opposite adjacent slot winding by an electrical angle of π/(3n)−θ.

In still another embodiment, a method of forming a stator assembly for a dynamoelectric machine includes configuring a core having a plurality of stator teeth and n sets of independent, three-phase windings disposed around the core. Each of the three phase windings are shifted from one adjacent slot winding by an electrical angle of π/(3n)+θ, and are shifted from the opposite adjacent slot winding by an electrical angle of π/(3n)−θ.

### BRIEF DESCRIPTION OF THE DRAWINGS

Referring to the exemplary drawings wherein like elements are numbered alike in the several Figures:

FIG. 1 is a sectional view of an AC generator incorporating a stator assembly and a rotor assembly rotatingly disposed therein, suitable for use in accordance with an embodiment of the present invention;

FIG. 2 is a sectional view of the rotor assembly portion of the generator shown in FIG. 1;

FIG. 3 is a schematic circuit diagram of an exemplary embodiment of a stator assembly portion of the generator of FIG. 1, wherein the stator assembly is provided with independent sets of three-phase windings;

FIG. 4 is a partial view of a stator core configured to have a variable stator tooth tip width for reducing magnetically induced noise in the alternator, in accordance with an embodiment of the invention;

FIG. 5 is another partial view of the stator core of FIG. 4, particularly illustrating examples of different sizes and types of conductors that may be formed within the slots of the stator core; and

FIG. 6 is another partial view of the stator core, particularly illustrating a capability of forming the core in a manner so as to facilitate the radial insertion of a continuous wire, in accordance with a further embodiment of the present invention.

### DETAILED DESCRIPTION

Disclosed herein is three-phase, synchronous AC alternator having phase shifted stator windings having a variable stator tooth tip width configured to reduce magnetically induced noise in the alternator. Whereas one or more previous configurations utilize n-sets of three phase windings physically shifted from one another by an electrical angle of 30 degrees, the present embodiments utilize an actual phase winding shift of 30+θ° with respect to the winding(s) of one adjacent slot, and a shift of 30−θ° with respect to the winding(s) of the other adjacent slot.

By implementing the ±θ offset shift, the mechanical noise from the fundamental frequency (resulting from the combination of the number of stator slots and hence winding holes and the number of blades on the fan) is consequently shifted into the side frequency bands. While this approach does not technically reduce the overall mechanical noise level, it does however significantly improve the tonal quality and acceptability of the noise. In other words “white noise” is more desirable than noise at one particular frequency. Accordingly, while a 30 degree shift of the stator windings might represent an ideal setting for the sole purpose of addressing magnetic noise, the approach taken herein provides a tradeoff with respect to a slight increase in magnetic noise for a significant reduction in mechanical noise through the angular shift between stator teeth.

Furthermore, in one exemplary embodiment, the present disclosure further enhances existing stator configurations by allowing for the radial insertion of a continuous wire, as is described in further detail hereinafter.

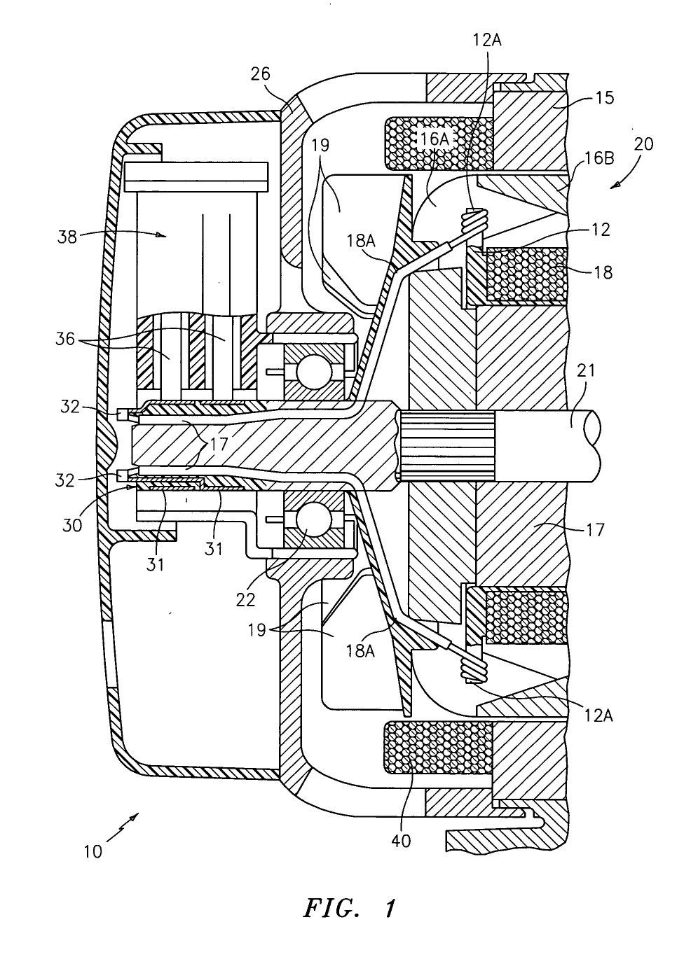

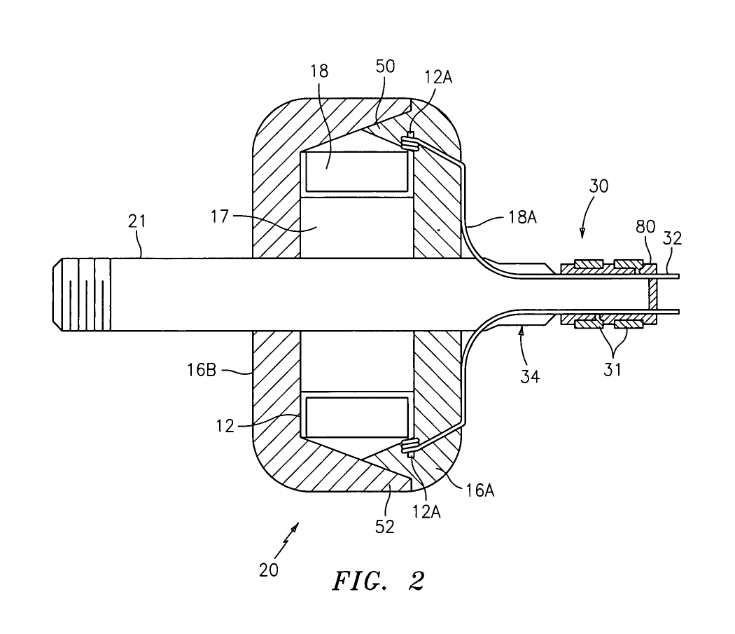

Referring initially to both FIGS. 1 and 2, an exemplary embodiment of an alternator 10 having a stator assembly 15 with a rotor assembly 20 rotatingly disposed therein is illustrated. The rotor assembly 20 includes a shaft 21 supporting each of the rotating magnetic circuit structures thereof, including conventional pole-members or segments 16A and 16B, rotor core 17 and field coil 18 wound upon bobbin 12. Each segment 16A and 16B has P/2 claw poles, where P is an even number and representative of the total number of poles. Additionally, all other non-magnetic circuit rotating structures are carried thereby, including air circulation fans 19 (only one shown) located at axially opposite sides of the pole-members, and a slip ring assembly 30 located at one extreme end of the shaft. One fan (not shown) may formed from sheet metal stock and spot welded to pole-member 16B while fan 19 is formed from an appropriate thermoplastic material and heat staked to tower extensions (not shown) from the field coil bobbin 12. The shaft 21 in turn is rotatably supported within a housing 26 by a pair of bearings 22 (only one shown). Bearing 22 (shown) is located between the slip ring assembly 30 and the fan 19.

As is shown in both FIGS. 1 and 2, coil leads 18A of field coil 18 are wrapped about respective posts 12A of bobbin 12 and pass through holes configured in fan 19. Slip ring assembly 30 is made of a pair of copper rings 31, each having a slip ring lead 32 joined such as by welding thereto. The copper rings and wires are molded into an insulative member 80, such as a molded cylinder of thermoset material for example, to complete the slip ring assembly. Slip ring assembly 30 is pressed onto the end of rotor shaft 21 and the slip ring leads 32 are routed into channels generally indicated at 34 in FIG. 2 along the shaft 21 where they are joined such as by soldering to the coil leads 18A of field coil 18.

The slip rings 31 are configured for supplying an electric current to the rotor assembly 20 via a pair of brushes 36 being housed in a brush holder 38 disposed inside housing 26 so as to slide in contact with these slip rings 31. A voltage regulator (not shown in FIGS. 1 and 2) adjusts the magnitude of an alternating voltage generated in a stator winding 40 of the stator assembly 15, and is operably coupled with the brush holder 38.

As described above, the rotor assembly 20 includes the field winding 18 for generating a magnetic flux on passage of an electric current, as well as pole cores or segments 16A and 16B disposed so as to cover the field windings 18. The magnetic poles are formed in the segments 16A and 16B by the magnetic flux generated by the field winding 18. The segments 16A and 16B, are made from a material such as iron, with each end segment 1 having two first and second claw-shaped magnetic poles 50 and 52, respectively, disposed on an outer circumferential edge and offsettingly aligned with each other in a circumferential direction so as to project axially. The end segment pole cores 50 and 52 are fixed to the shaft 21 facing each other such that the claw pole of one core is aligned with a gap defined between contiguous claw poles of the other core and intermesh with the opposing magnetic poles of the other core as is well known in the art of Lundell rotor assemblies.

In the dynamoelectric machine 10 constructed in this manner, an electric current is supplied to the field windings 18 from the storage battery (not shown in FIGS. 1 and 2) through the brushes 36 and the slip rings 31, generating a magnetic flux. The first claw-shaped magnetic poles 50 of segments 16A are magnetized into a fixed polarity by this magnetic flux (such as north seeking (N) poles), and the second claw-shaped magnetic poles 52 of segment 16B are magnetized into the opposite polarity (such as south seeking (S) poles). At the same time, rotational torque from the engine is transmitted to the shaft 21 by means of the belt (not shown) and the pulley (not shown), rotating the rotor assembly 20. Thus, a rotating magnetic field is imparted to the armature winding 40 of stator assembly 15, thereby inducing a voltage across the armature winding 38.

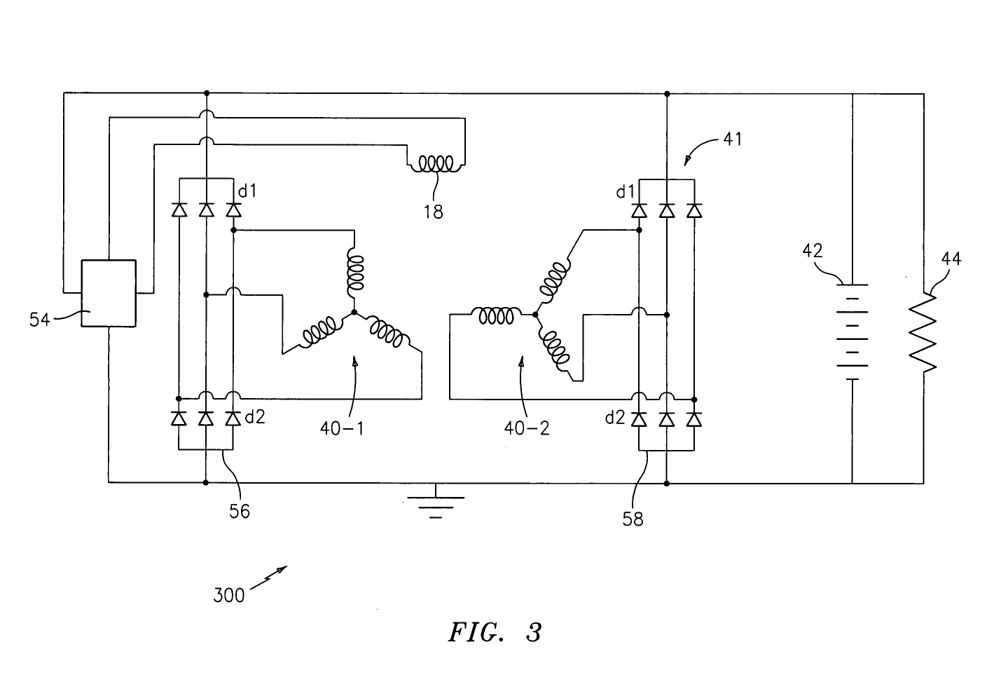

FIG. 3 is a schematic circuit diagram of an exemplary embodiment of the stator portion 15 of the generator of FIG. 1. A rectifier (one of two generally indicated at 41) is configured for converting alternating current generated in the stator 4 into direct current and is mounted inside housing 26. The rectifier 41 is more specifically embodied by a three-phase, full-wave rectifier in which three diode pairs, respectively, are connected in parallel. Each diode pair includes a positive-side diode d, and a negative-side diode d₂ connected in series. The output from the rectifier 41, for example, may be supplied to a storage battery 42 and an electric load 44. Thus, the alternating-current electromotive force is passed through rectifiers 41 and is converted into direct current, the magnitude thereof being adjusted by a voltage regulator 54. In so doing, a storage battery 42 is charged, and the current may also be supplied to an electrical load 44.

As indicated above, along with electrical load escalation, there is a continuing desire for lower allowable underhood noise, particularly magnetic noise. Thus, to address this concern, the stator 40 includes two independent sets of three-phase windings 40-1 and 40-2 that are each coupled to a corresponding three-phase rectifier, 56 and 58, respectively. In earlier implementations of stator assemblies having independent three-phase windings, the windings are physically shifted from one another in adjacent stator slots by an electrical angle of π/(3n) radians, with n being the number of independent sets of three-phase windings employed. Thus, where two independent sets of three-phase windings are used in a stator assembly, the windings were heretofore separated from one another by precisely by π/6 radians, or 30°.

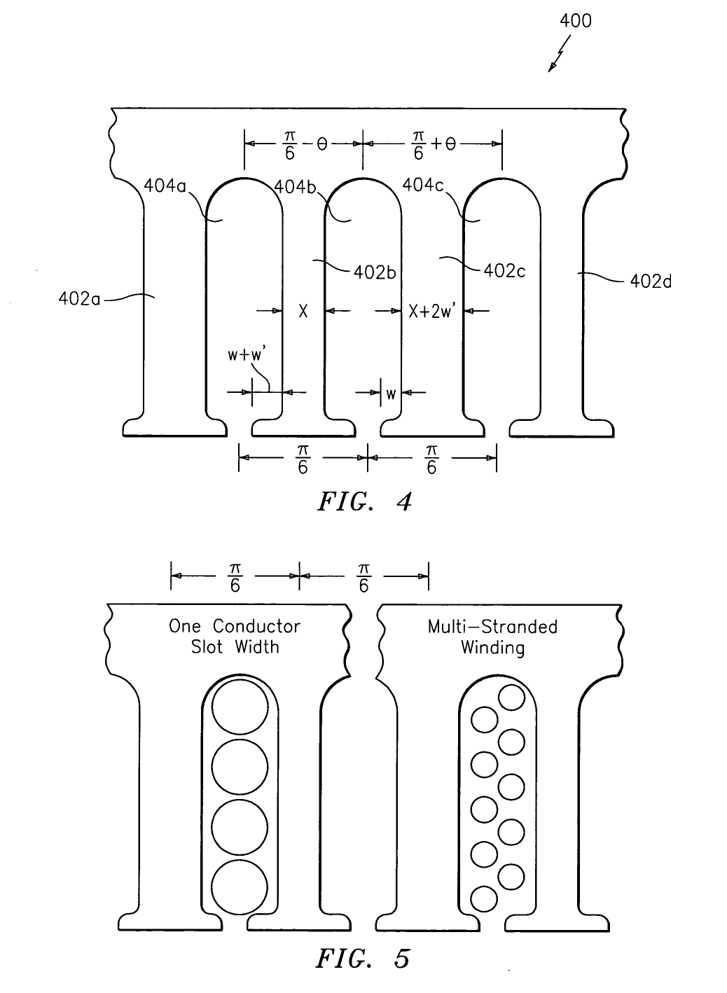

Therefore, in accordance with an embodiment of the invention, FIG. 4 is a partial view of a stator core 400 configured to have a variable stator tooth tip width for reducing magnetically induced noise in the alternator. As is shown, the stator core includes a plurality of stator teeth 402a, 402b, 402c, and 402d. It should be easily recognized that since FIG. 4 is just a partial view of the stator core 400, only a few of the teeth are actually illustrated therein. However, the representative view in FIG. 400 is sufficient for an understanding of the particular configuration of the teeth (and the tips of the teeth) with respect to one another that results in the specific phase shifting described herein.

For example, the width of the tip of tooth 402c is defined by the dimension “w” in FIG. 4, whereas the tip of tooth 402b is defined by the dimension “w+w′.” As a result, if the width of tooth 402b is given by the dimension “x” in FIG. 4, the width of tooth 402c will therefore be x+2w′. By alternating the width of the tooth tips for adjacent stator teeth between “w” and “w+w′,” the resulting effect is to create an electrical angle phase shift of 30° plus a small offset angle, θ, in one direction, and 30° minus the offset angle, θ, in the other direction. Thus, for example, because the tip width of teeth 402a and 402c is “w” and the tip width of teeth 402b and 402d is “w+w′,” it will be seen that the offset between windings eventually inserted in slot 404a will be shifted by π/6−θ from windings in slot 404b, while windings eventually inserted in slot 404c will be shifted by π/6+θ from windings in slot 404b.

The particular values of w and w′ selected in configuring the varying tooth tip width will determine the value of the offset angle, θ (which may be expressed in either radians or degrees). In an exemplary embodiment, w and w′ are chosen such that θ is on the order of about 2 electrical degrees. Accordingly, using the above example, the stator core 400 includes of two sets of independent three-phase windings that are offset from each other by about 28 electrical degrees on one side and by about 32 electrical degrees on the other. Other values of θ are also contemplated, however.

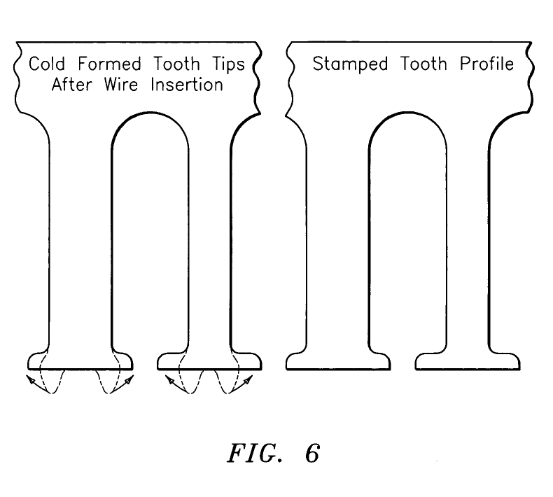

FIG. 5 illustrates the flexibility in the selection of the shape of the winding conductor material (e.g., round, oval, square, etc.), as well as the type of strands used (e.g., single stranded, multi stranded). It will further be appreciated that the stator tooth tips can be either stamped directly to their final geometry, or stamped and thereafter cold formed into their final geometry. With such an approach, it is possible to radially insert wire (either multi-stranded or one conductor width), and then form the tooth tips to close the slot opening. This eliminates the need for axial insertion and multiple welds of the ends of a segmented conductor. As particularly shown in FIG. 6, the tooth tips may be radially formed by deformation from an initial shape (shown in dashed lines) after the wires are inserted into the slots. Additional information regarding this tip forming methodology may be found in co-pending application publication US2003/0033709, the contents of which are incorporated by reference herein in their entirety.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A stator assembly for a dynamoelectric machine, comprising:
a core having a plurality of stator teeth and n sets of independent, three-phase windings disposed around the core;
wherein each of said three phase windings are shifted from one adjacent slot winding by an electrical angle of π/(3n)+θ, and are shifted from the opposite adjacent slot winding by an electrical angle of π/(3n)−θ; and
wherein said three phase windings are shifted from one another by a magnetic angle of π/(3n).

2. (canceled)

3. A stator assembly for a dynamoelectric machine, comprising:
a core haying a plurality of stator teeth and n sets of independent, three-phase windings disposed around the core;
each of said three phase windings being shifted from one adjacent slot winding by an electrical angle of π/(3n)+θ, and shifted from the opposite adjacent slot winding by an electrical angle of π/(3n)−θ;
said plurality of stator teeth configured so as to have a first subset thereof having a first tooth tip width and a second subset thereof having a second tooth tip width;
said first tooth width of said first subset of stator teeth defined by a first dimension, w;
said second tooth tip width of said second subset of stator teeth defined by a second dimension, w+w′, which is greater then said first dimension;
said first subset of stator teeth having a first width, x; and
said second subset of stator teeth having a second width, x+2w, which is greater than said first width.

4. The stator assembly of claim 3, wherein θ represents an offset angle of about 2 degrees.

5. The stator assembly of claim 3, wherein said plurality of stator teeth are configured in a manner so as to allow both n radial insertion of windings around said core, and axial insertion of segmented windings in said core.

6. The stator assembly of claim 3, wherein n=2.

7. A dynamoelectric machine, comprising:
a rotor having two or more flux carrying segments, with each segment having P/2 claw poles, wherein P is am even number;
a stator assembly having said rotor rotatingly disposed therein, said stator assembly further comprising a core having a plurality of stator teeth and n sets of independent, three-phase windings disposed around said core;
wherein each of said three phase windings are shifted from one adjacent slot winding by an electrical angle of π/(3n)+θ, and are shifted from the opposite adjacent slot winding by an electrical angle of π/(3n)−θ; and
wherein said three phase windings are shifted from one another by a magnetic angle of π/(3n).

8. (canceled)

9. A dynamoelectric machine, comprising:
a rotor having two or more flux carrying segments, with each segment having P/2 claw poles, wherein P is an even number;
a stator assembly having said rotor rotatingly disposed therein, said stator assembly further comprising a core having a plurality of stator teeth and n sets of independent, three-phase windings disposed around said core;
each of said three phase windings shifted from one adjacent slot winding by an electrical angle of π/(3n)+θ, and shifted from the opposite adjacent slot winding by an electrical angle of π/(3n)−θ;
said plurality of stator teeth configured so as to have a first subset thereof having a first tooth tip width and a second subset thereof having a second tooth tip width;
said first tooth tip width of said subset of stator teeth defined by a first dimension, w;
said second tooth tip width of said second subset of stator teeth defined by a second dimension, w'w′, which is greater than said first dimension;
said first subset of stator teeth having a first width, x; and
said second subset of stator teeth having a second width, x+2w, which is greater than said first width.

10. The dynamoelectric machine of claim 9, wherein θ represents an offset angle of about 2 degrees.

11. The dynamoelectric machine of claim 9, wherein said plurality of stator teeth are configured in a manner so as to allow both a radial insertion of windings around said core, and axial insertion of segmented windings in said core.

12. The dynamoelectric machine of claim 9, wherein n=2.

13. A method of forming a stator assembly for a dynamoelectric machine, the method comprising:
configuring a core having a plurality of stator teeth and n sets of independent, three-phase windings disposed around the core;
wherein each of said three phase windings are shifted from one adjacent slot winding by an electrical angle of π/(3n)+θ, and are shifted from the opposite adjacent slot winding by an electrical angle of π/(3n)−θ; and
wherein said three phase windings are shifted from one another by a magnetic angle of π/(3n).

14. (canceled)

15. A method of forming a stator assembly for a dynamoelectric machine, the method comprising:
configuring a core having a plurality of stator teeth and n sets of independent, three-phase windings disposed around the core;
each of said three phase windings shifted from one adjacent slot winding by an electrical angle of π/(3n)+θ, and shifted from the opposite adjacent slot winding by an electrical angle of π/(3n)−θ;
said plurality of stator teeth configured so as to have a first subset thereof having a first tooth tip width and a second subset thereof having a second tooth tip width;
said first tooth width of said first subset of stator teeth defined by a first dimension, w;
said second tooth tip width of said second subset of stator teeth defined by a second dimension, w+w′, which is greater than said first dimension;
said first subset of stator teeth having a first width, x; and
said second subset of stator teeth having a second width, x+2w, which is greater than said first width.

16. The method of claim 15, wherein θ represents an offset angle of about 2 degrees.

17. The method of claim 15, wherein said plurality of stator teeth are configured in a manner so as to allow both a radial insertion of windings around said core, and axial insertion of segmented windings in said core.

18. The method of claim 15, wherein n=2.

19. The method of claim 17, further comprising:
radially inserting windings around said core; and
following said radially inserting windings, deforming the tips of said plurality of stator teeth so as to form said first tooth tip width of said first subset of stator teeth and said second teeth tip width of said second subset of stator teeth.
